(19) United States
(12) Patent Application Publication
(10) Pub. No.: US 2011/0099788 A1
(43) Pub. Date: May 5, 2011

(54) FINAL ASSEMBLY MACHINE AND METHOD OF USE

(75) Inventor: Velibor Kilibarda, West Bloomfield, MI (US)

(73) Assignee: COMAU, INC., Southfield, MI (US)

(21) Appl. No.: 12/913,908

(22) Filed: Oct. 28, 2010

Related U.S. Application Data
(60) Provisional application No. 61/256,551, filed on Oct. 30, 2009.
(60) Provisional application No. 61/358,668, filed on Jun. 25, 2010.

(51) Int. Cl. B23P 11/00; B62D 65/18; B66D 3/20; B62D 65/02; B23P 19/04

(52) U.S. Cl. 29/428; 254/2 R; 254/4 R; 29/244

(57) ABSTRACT

A final assembly machine and method of using the final assembly machine for the sequential building and assembly of a passenger vehicle. The final assembly machine includes a frame, body support and lifting device for receiving, supporting and selectively and independently raising and lowering a vehicle body along a production assembly line while additional components are installed on the vehicle. Component carts may be removably attached to the assembly machines to provide the necessary components to be installed along the assembly line eliminating storage of build components next to the assembly lines. In one example, the final assembly machines may be independently powered, and guided along an assembly line through a plurality of build stations for increased efficiency and use of assembly plant resources.

### CROSS-REFERENCE TO RELATED APPLICATION

This application claims the priority benefit of both U.S. Provisional Patent Application Ser. Nos. 61/256,551 filed on Oct. 30, 2009 and Provisional Patent Application Ser. No. 61/358,668 filed on Jun. 25, 2010 the entire contents of both applications are incorporated herein by reference.

### FIELD OF THE INVENTION

The present invention generally relates to the assembly of motorized vehicles.

### BACKGROUND OF THE INVENTION

The design, development and assembly of motorized vehicles has undergone much innovation and advancement over the past decades. With the general rise of the sales of vehicles has come increasing demand for the speed of the manufacture and assembly of vehicles while increasing the quality of the build.

Conventional vehicle assembly plants require a substantial amount of build out and capital investment in order to accommodate the assembly of a specific vehicle or small number of similar vehicles. These facilities have utilized numerous, long and complex automated vehicle body conveying systems to transfer, for example, the heavy and large sheet metal vehicle bodies throughout the plant passing from the body framing where the sheet metal components are welded together. The vehicle body must then be physically transferred through the coating and painting areas and then through the dozens of discrete assembly stations where powertrain and chassis are decked and remaining interior and exterior components are installed to complete a drivable vehicle.

Automated transfer of the vehicle throughout the plant conventionally required combinations of overhead conveying systems which suspend and support the vehicle and in-ground conveying systems which pull the vehicle body along a selected path close to ground level. Both conveying systems require substantial plant architecture and structure. The overhead conveyors must support tens of thousands of pounds to support dozens and dozens of vehicle bodies traveling through the plant. The in-ground conveyors and drive mechanisms must be packaged underground in pits so as to keep the vehicles close to ground level. These automated transfer systems require complex transition areas where the vehicles are released from one transfer convey to another. In conventional systems, due to the vehicle paths in and out of various build areas, they are often required to be elevated or otherwise maneuvered to accommodate other assembly areas and other moving vehicle bodies in an attempt to keep a continuous flow of vehicles through the facility. As such, much of the travel path of the vehicle renders it in positions where it cannot efficiently or safely be worked on by plant workers greatly reducing the efficiency of the build. In some asserted modern plants, workers can only access and carryout out build functions along 30% of the vehicle's total path of travel.

Conventional facilities further typically house or store bins of subassemblies or components next to the assembly line where workers pull parts from the bins and connect the components to the vehicle as it passes through the build station. The storage of parts on the assembly floor next to or in close proximity of the assembly line takes up a substantial amount of plant floor space and greatly increases the plant logistics in coordinating and restocking the bins to keep production moving. If a particular build station runs out of parts, or there is a significant problem with a single vehicle, the entire assembly line may have to be shut down until the problem is resolved.

There is a substantial need to improve or solve these deficiencies and disadvantages on the conventional build and assembly process and associated devices.

### SUMMARY OF THE INVENTION

The present invention provides a final assembly machine (FAM) device and a method of assembly using the final assembly device for exemplary use in the build and final assembly of passenger vehicles along a predetermined assembly line path of travel. In an exemplary application, a plurality of FAMs are provided and sequentially oriented along an assembly line path of travel. In a preferred example, the FAMs are independently driven by a powered drive through a plurality of build stations positioned along the assembly line path.

In one example of the inventive apparatus, each FAM includes a frame, a body support to receive and support a partially completed vehicle body, a lift mechanism connected to the frame for selectively raising and lowering the vehicle body and a power drive to drive the FAM independently of any other FAMs.

In one example, the FAM frame includes at least two pillars connected to the body support and lift mechanism. In one example, the at least two pillars includes four pillars which in combination with the body support, suspend the vehicle body from the frame.

In one example, the FAM frame includes a pallet supporting a pair of pillars connected to the body support and lift device. The pallet may include the power drive in the form of at least one electric motor operably engaged with at least two wheels for independently driving the cart along the assembly path of travel.

In alternate examples to power the FAM, an induction power source and motor system may be used. In an alternate example, a separate and independent automated guided vehicle may be used to dock with an FAM pallet and provide the drive and auxiliary power source to the pallet.

In one example of an FAM, independent component carts are removably attached to the FAM frame, for example the pallet, and follow the driven FAM along the path of traveling providing the necessary components and subassemblies to be installed on the vehicle body along the various build stations.

In an exemplary build process using a final assembly machine having one or more features described above, a partially completed vehicle body is installed in the FAM, the FAM is independently powered along an assembly line path of travel and the vehicle body is selectively raised or lowered at the various build stations to maximize access to the vehicle for installation of the components.

In one exemplary build process, a plurality of FAMs are provided and independently driven and guided along a predetermined assembly line path of travel.

In another example, the FAMs are either in selected groups or all of the FAMs are connected together and/or connected to a common drive system which moves the group or all of the FAM at substantially the same rate and at a predetermined distance between the individual FAMs.

In one example of the build process, at least one component cart is engaged to the FAM and travels along with the FAM through the assembly line providing ready access to the necessary components to be installed on the vehicle body. On completion of a specific assembly line or sequence of build stations, the component depleted carts are sequentially returned to be restocked with components and sequenced for connection to a subsequent FAM passing through that specific assembly line.

In one example, a fully completed vehicle is removed from the FAM and the empty FAM is returned to a starting position or holding area to be resequenced with another partially completed vehicle body to be assembled.

### BRIEF DESCRIPTION OF THE DRAWINGS

The various features, advantages and other uses of the present invention will become more apparent by referring to the following detailed description and drawing in which:

FIG. 1 is a schematic perspective view of first example of a final assembly machine according for use in assembling a passenger vehicle;

FIG. 2 is a side elevational view of the example shown in FIG. 1;

FIG. 3 is a rear elevational view of the example shown in FIG. 1 with the vehicle in an elevated position;

FIG. 4 is a plan view of the example shown in FIG. 1;

FIG. 5 is a schematic perspective view of an alternate example of a final assembly machine for use in assembling a passenger vehicle;

FIG. 6 is a side elevational view of the example shown in FIG. 5;

FIG. 7 is a rear elevational view of the example in FIG. 5 showing the vehicle body in an elevated position;

FIG. 8 is a schematic perspective view of an example of an automated guided vehicle used in the example shown in FIGS. 5-7;

FIG. 9 is a schematic perspective view of another example of a final assembly machine for use in assembling a passenger vehicle;

FIG. 10 is a rear view of the example shown in FIG. 9 with the vehicle in a raised position;

FIG. 11 is a perspective view of one example of a lifting device illustrated in FIG. 11;

FIG. 12 is an enlarged partial perspective view of the vehicle support shown in FIG. 11;

FIG. 13 is an alternate view of FIG. 10 illustrating one example of an induction power drive system for the final assembly machine;

FIG. 14 is a rear view of one example of an alternate power drive system using an overhead power drive system for the final assembly machine;

FIG. 15 is a rear view of the final assembly machine shown in FIG. 10 during a chassis decking process with an example of a chassis cart;

FIG. 16 is an alternate view of FIG. 15 shown with the vehicle lowered to install the chassis;

FIG. 17 is a schematic of one example of an assembly process using the inventive final assembly machine;

FIG. 18 is a schematic of an alternate example of an assembly process using the inventive final assembly machine;

FIG. 19 is a schematic plan view of a portion of an assembly plant using a plurality of final assembly machines along with use of a plurality of part carts; and

FIG. 20 is a flow chart of examples of an assembly process using the inventive final assembly machine.

### DETAILED DESCRIPTION OF EXAMPLES OF THE INVENTION

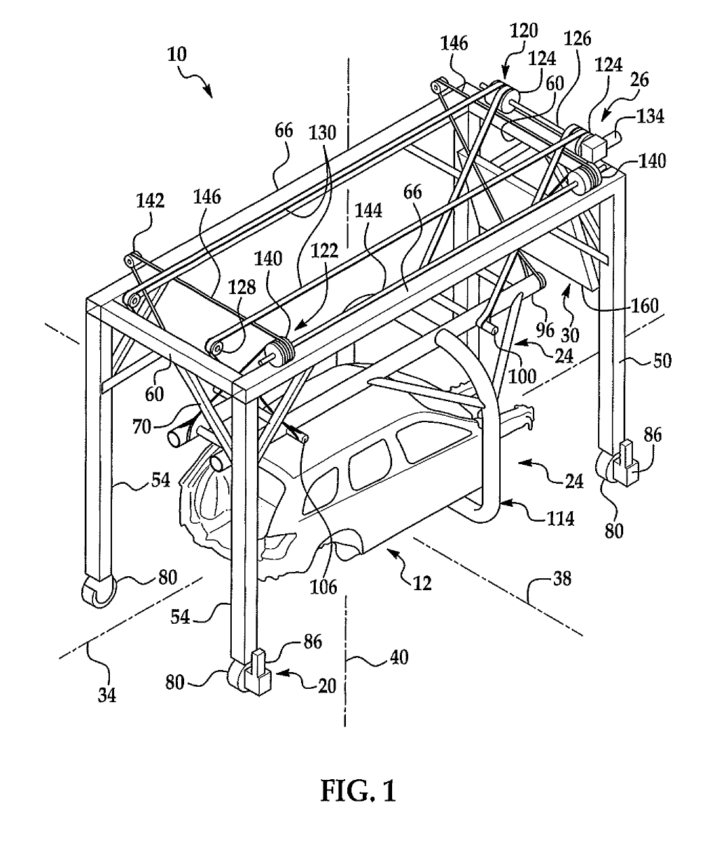

Several examples of the inventive final assembly machine (FAM) 10 and methods of use are shown in FIGS. 1-20. Referring to FIGS. 1 and 5, two alternate examples of the FAM are illustrated and further described below.

Referring to FIGS. 1-4, a first example of an FAM 10 for exemplary use in assembling a passenger vehicle body 12 is shown. In a preferred example, vehicle body 12 is a sheet metal body that has been through a production paint process.

As best seen in the example in FIG. 1, FAM 10 includes a frame 14, a powered frame drive 20, a vehicle body support cradle 24, a body raising and lowering mechanism 26 and an operator audio and video interface or display 30. In a preferred example, FAM 10 is used along a vehicle production assembly line, path of travel or axis 34. The assembly plant (not shown) and assembly line 34 further includes a lateral direction or axis 38 and a vertical direction or axis 40 as generally shown. It is understood that the FAM may be used for the assembly of other machines and devices other than passenger automobiles as understood by those skilled in the art.

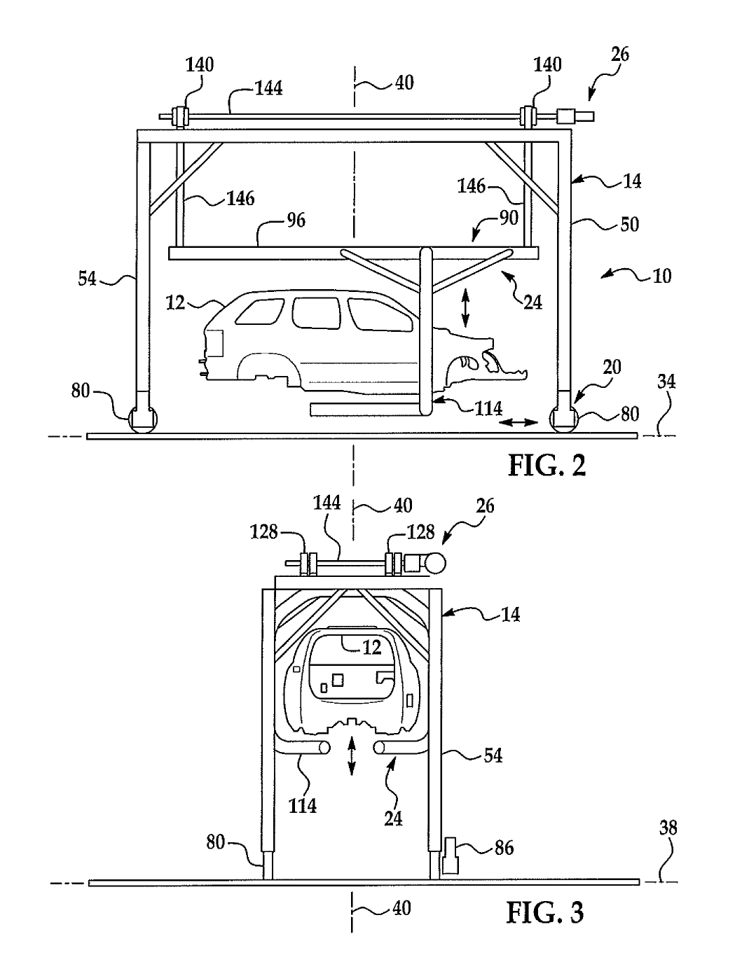

Referring to FIGS. 1 and 2, frame 14 includes a pair of front, substantially vertical pillars 50, similarly constructed rear pillars 54 spaced from the front pillars along axis 34. Each set of pillars 50 and 54 includes a lateral beam 60 and longitudinal beam 66 connecting the respective pillars as generally shown. Additional cross bracing 70 may be used to further strengthen the frame 14 as needed to meet the specification requirements.

Frame 10 further includes industrial wheels or casters 80 at the lower end of the pillars for omni-directional movement of frame to in a selected direction along axes 34 and 38 and rotationally about vertical axis 40. In a preferred example, one front pillar 50 and one rear pillar 54 include an electric motor 86 which selectively and independently forcibly rotates the respective wheel 80 to move frame 10 and body 12 in the desired direction. In a typical example, FAM Electric motor 86 can be powered by a rechargeable battery source connected to frame 14.

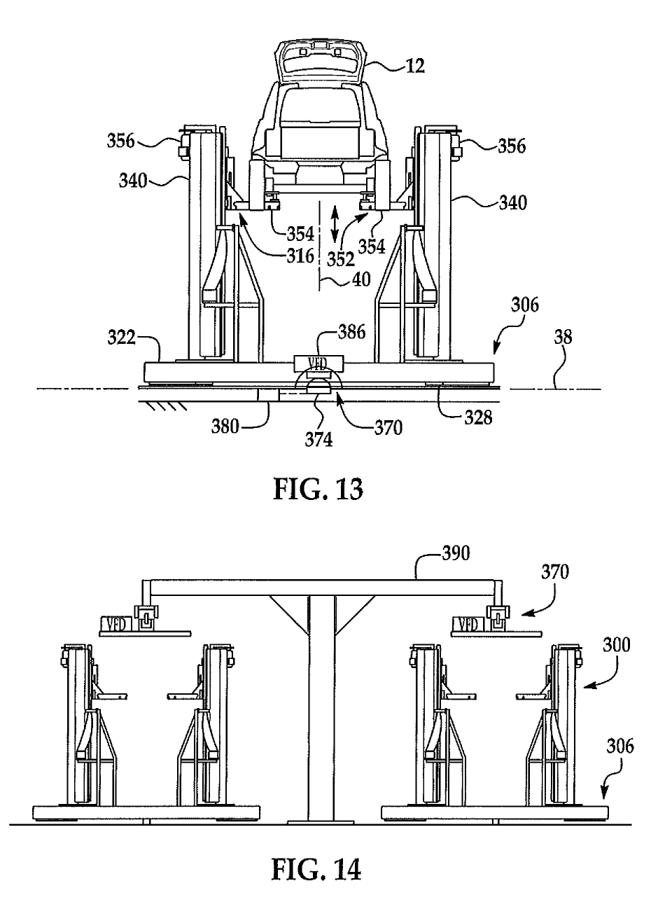

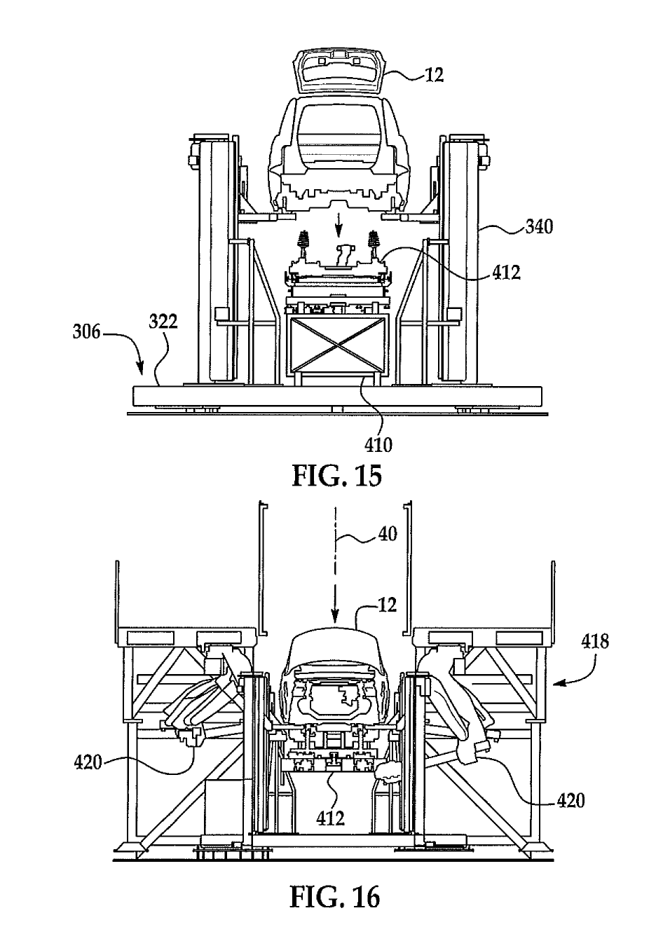

Referring to FIGS. 13 and 14, other methods of locomotion for FAM 10 are shown. In FIG. 15, an induction power drive system is schematically illustrated. In the example, a conductive wire or cable 374 in a closed circuit is secured along the selected path, or paths, of travel 34 and is connected to a power source (not shown) located remotely in the assembly plant. The cable 374 may be positioned and secure in a shallow groove in the plant floor or attached atop of the floor surface or by other means known by those skilled in the field. The cable 374 may be in electrical communication with a separate controller 380 positioned adjacent to the cable 374 to send and receive signals from a remote control center (not shown). The controller 380 may further have a microprocessor and storage capabilities to execute preprogrammed commands, for example, to increase or slow the linear speed of the FAM along path 34 until in communication with the next controller 380 along path 34, redirect the FAM to an alternate path of travel (not shown) or momentarily stop the FAM until a time delay passes or subsequent command signal is received.

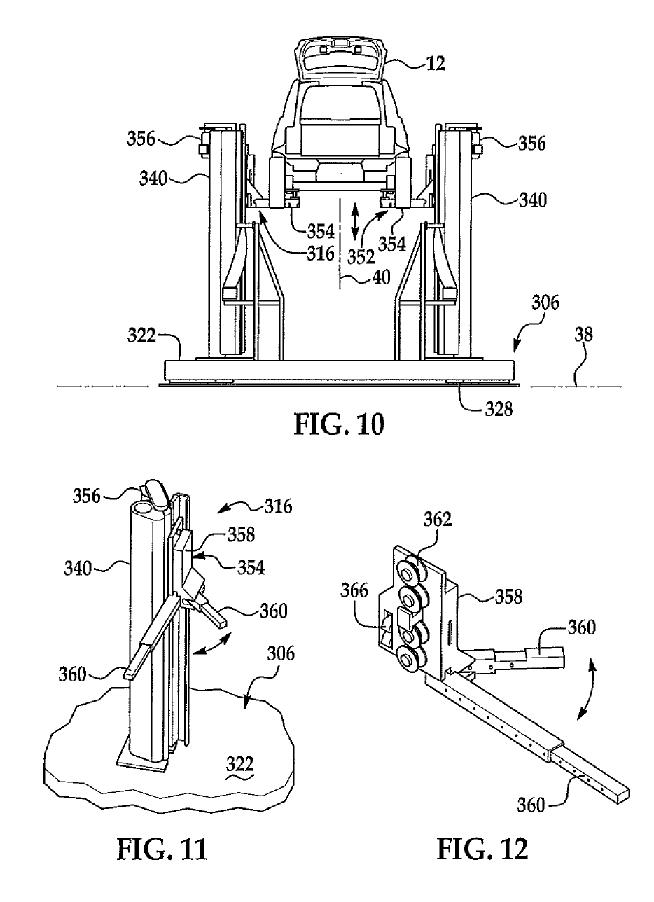

In the example, the electric and/or magnetic field given off by the powered cable 374 is received by a controller 386 on the pallet 306 (or 206). The controller supplies the electricity to electrical motors (not shown) in driving engagement with one or more wheels 328 in FIGS. 9 and 10 (or 228) to selectively power the pallet along the path of travel 34. A suitable system is manufactured by Conductix-Wampfler AG under the IPT® (Inductive Power Transfer) brand for floor applications. The exemplary system may also be used with Conductix-Wampfler iDAT data communication systems which would permit data to be transferred to and from the final assembly machine 10/200 to selectively and individually propel the individual FAMs along a selected path of travel 34.

In FIG. 14, an overhead trolley-type power driven system is generally illustrated. In the example, an induction system may be used as described above in FIG. 15 instead of a floor based system. Alternately, a conductive brush arrangement may be used wherein electricity is transferred directly from a power cable, through conductive brushes, through conductive wires to electrical motors to drive the pallet wheels as generally described above. The trolley-type devices are less preferred as they would require additional build out structures such as columns 390.

Although several examples of propulsion systems have been described, it is understood that other methods, or combinations of methods, for selectively and independently driving the FAMs 10 along a selected path, for example chain or cable driven devices (not shown), known by those skilled in the art may be used. For example, although in some of the described drive or propulsion and guidance systems provide for independent and movement and guidance of each individual FAM along the path of travel 34, a chain or cable driven system wherein each FAM is connected to the chain or cable at a desired interval between FAMs may collectively drive selected group of FAMs or all of the FAMs passing along a particular assembly line. In such a chain or cable driven system, each FAM would not typically be capable of independent movement or guidance without disconnecting the FAM from the drive or electrically conductive cable. Although some of the examples provide that the individual FAMs are separate or independent of one another, an alternate example provides that the FAMs are directly connected or coupled together through a link (not shown) wherein a selected group or all of the FAMs passing along a particular assembly line are removably connected to one another and move together at a predetermined speed along path 34.

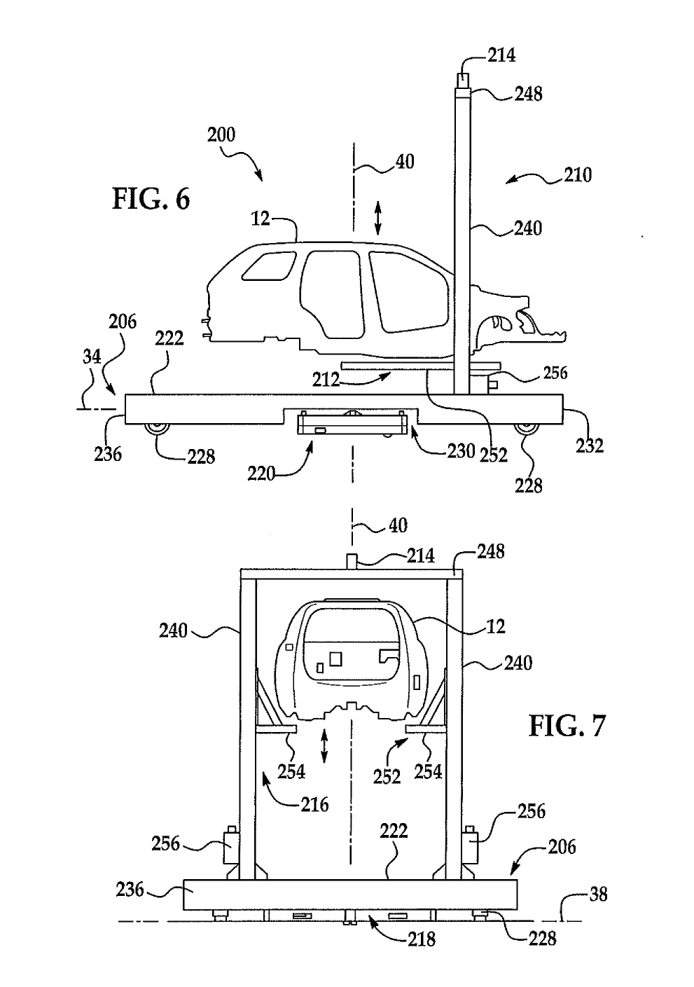

In a typical example, electric motors 86 move frame 14 down a predetermined path of travel along assembly line 34 through a plurality of separate and sequentially positioned build stations (not shown) where other components such as exterior body panels, for example doors, instrument panel (IP), exterior and interior trim components and the vehicle powertrain and chassis (all not shown) are positioned, installed and secured to the vehicle sheet metal body by human operators, industrial robots (not shown) or combinations thereof. Examples of general paths of travel 34 are shown in FIGS. 5 and 6 discussed further below.

As best seen in FIGS. 1-3, frame 14 body cradle 24 includes a body support 90 for supporting vehicle body 12 in FAM 10. In the example shown, support 90 includes a pair of elevated longitudinal frame members 96 separated and secured to one another by a front cross member 100 and a rear cross member 106 as generally shown. The longitudinal and cross members may be made from round steel or aluminum tubing or other industrial bar stock as known by those skilled in the field. Other frame or truss member structures other than that illustrated may be used to suit the particular application.

The exemplary body support 90 further includes support arm 114 that extends downward from longitudinal members 96 to wrap under the vehicle body 12 to vertically support the weight of body 12 and provide a secure platform for the vehicle to remain on during the assembly process. Support arm 114 may include temporary attachment devices (not shown) to physically engage and securely hold body 12 to the support arm 114 until released (Body 12 shown elevated from support arm 114 for illustrative purposes only).

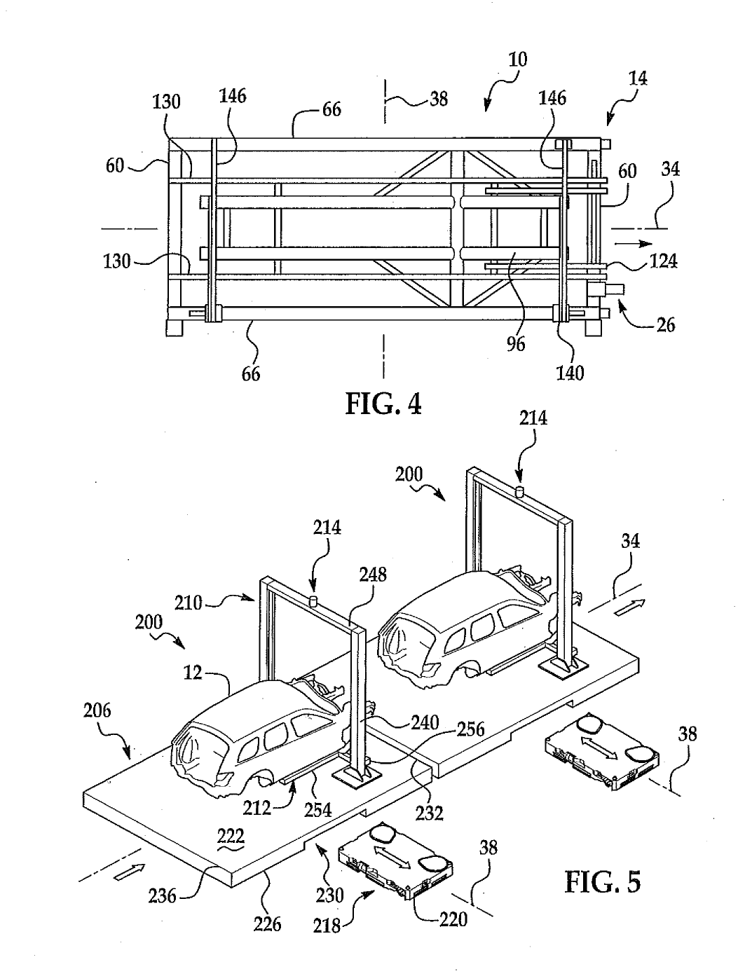

In the example shown in FIGS. 1-4, FAM 10 includes a first lifting device 120 and a second lifting device 122 that cooperatively operate to selectively raise and lower body 12 along axis 40 to facilitate positioning of the body 12 for the particular assembly process at each build station. First lifting device includes a pair of rotatable drums 124 connected by a shaft 126 for cooperative rotating operation and opposing pulleys 128 substantially aligned and separated from drums 124 as best seen in FIGS. 1 and 4. A pair of straps 130 having respective first ends are attached to the front cross member 100, are wrapped around drums 124, extend between the lateral beams 60, pass over pulleys 128 and are respectively secured at second ends to the rear cross member 106 as generally shown. Lifting device 120 further includes an electric motor 134 rotatably engaged with shaft 126 to simultaneously rotate shaft and drums 124 thereby moving straps 146 to raise or lower body 12 as desired for the particular build station or assembly operation.

Second lifting device 122 further includes drums 140 positioned on longitudinal members 96 and connected by shaft 144, opposing pulleys 142 and straps 146. Straps 146 have first and second ends that are oriented in criss-cross fashion and connect to respective longitudinal beams 196 as generally shown. Drums 140 may be powered by motor 134 or a separate electric motor (not shown) synchronized with motor 134 so on actuation of motor 134, drums 124 and 140 rotate thereby moving respective straps 130 and 146 to raise or lower body support 90 and body 12 in a controlled, stable and secured manner as desired from build station to build station. Straps 130 and 146 maybe be industrial fabric web or nylon straps, reinforced elastomeric belts, braided steel cable or other devices and materials to suit the weight and particular performance specifications as known by those skilled in the art.

In the example FAM 10 shown, a human operator interface (HMI) 30 may be used to provide visual and audio instruction, training, prompts, safety warnings and other messages to adjacent users. The HMI may include a visual monitor 160, audio speakers and other known communication devices. Monitor 160 may be positioned in alternate areas on the FAM 10, for example connected to pillars 50.

In a preferred example, a plurality of FAMs 10 are employed in an assembly plant (not shown) along a predetermined and sequentially staged assembly line 34. The FAMs are sequentially aligned and selectively and independently moveable from adjacent FAMs. For example, the distance or spacing between sequential and directly adjacent FAM along assembly line 34 can vary or be different to accommodate the build, variations in the process, irregular events that occur in the course of a shift and other reasons known by those skilled in the field.

Referring to FIGS. 5-8, an alternate example of a final assembly machine (FAM) 200 is illustrated (two FAMs shown). In the example, each FAM 200 includes a pallet 206, a frame 210, a vehicle body support 212, a lift mechanism 216, and drive mechanism 218 shown in the form of an automated guided vehicle (AGV) 220 as an example. In the example shown, FAM 200 further includes a scanner 214 used, for example, to assist in the maneuvering of the FAM 200 along the path of travel 32. In one example, the scanner may be a laser-type scanner which receives reflective, bounce-back signals from stationary objects so the FAM can navigate or otherwise avoid them. The FAM 200 may further include an antennae to receive and or send signals from and to a central command center.

As best seen in FIGS. 5-7, FAM 200 pallet 206 preferably includes an upper surface 222, a lower surface 226 defining a docking station or slot 230, and wheels or casters 228 positioned proximate to the corners or sides of the pallet 206. Pallet 206 includes a front 232 and a rear 236 separated along assembly line path of travel or axis 34.

FAM 200 further includes a frame with a pair of substantially vertical pillars 240 and a lateral beam 248 spanning and connecting the pillars as generally shown. More than one pair of pillars and lateral beams may be used depending on the application and performance specification.

In a preferred example as best seen in FIGS. 6 and 7, FAM 200 body support 212 includes a carriage 252 used to support the vehicle body 12. In the example shown, each pillar 240 includes a support 254 movably connected to the respective pillar allowing the supports 254 to synchronously and selectively move up and down along axis 40 to a selected height to maximize access to the particular body 12 area to install selected components at build stations or otherwise perform operations on the body 12 as needed. Similar in function to supports 114 in the alternate example, supports 254 may include fastening devices to secure and hold body 12 to the frame 210 during the FAMs path of travel (body 12 shown elevated from supports 254 for ease of illustration).

FAM 200 lift mechanism 216 includes at least one electric motor 256 (two shown) in operable engagement with pillars to selectively move supports 254 and body 12 along axis 40 to raise and lower the body 12. In a preferred example, each pillar 240 includes a sprocket and chain device (not shown) in operable engagement with the motor 256 and support 254 to transfer rotational movement of the motor to linear movement of the support 254 as generally known by those skilled in the field. Other lifting mechanisms may be used for example, cables, hydraulics, pneumatics and other systems to suit the particular body 12 size and weight and performance specifications known by those skilled in the art.

In a preferred example, each FAM 200 utilizes an automated guided vehicle (AGV) 220 to drive the pallet 206 along the assembly line/path of travel 24. In one example, the AGV 220 further provides auxiliary electrical power to the pallet 206 to, for example, power the lift mechanism 216. Alternately, an alternate source, such as an auxiliary rechargeable batter connected to the pallet 206 may provide auxiliary power to the pallet 206.

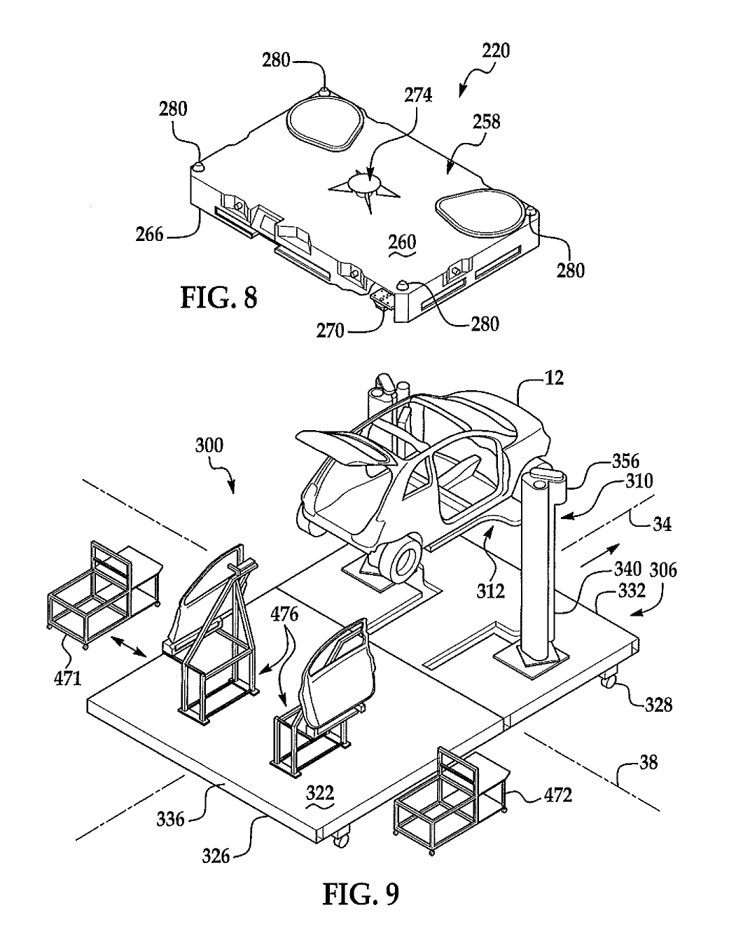

As best seen in FIGS. 5 and 8, the exemplary AGV 220 includes a low profile housing 258 having an upper surface 260, a lower surface 266, wheels or casters 270 and a scanner or locating device 274. In a preferred example, the AGV 220 includes a microprocessor and controller for storage and execution of software or other commands or signals to power and navigate the AGV 220 along a predetermined path of travel as further described below. In an alternate example, AGV 220 may receive signals or commands from a remote command center or controller adjacent the assembly line 34 or other area of the plant by wireless communication devices and protocols, including but not limited to, global positioning satellite (GPS) related technology, known by those skilled in the field. AGV 220 further includes a power source, for example rechargeable battery cells, and one or more electric motors (not shown) to drive two or more wheels 270 for linear movement of the AGV along the predetermined path, for example assembly line 34. Each AGV is capable of omni-directional movement along the assembly line 34, lateral axis 38 as well as in a rotational direction about vertical axis 40. In one example, scanner 274 is a laser-type scanner as previously described for scanner 214 to assist in the maneuvering of AGV 220 to and from the pallet 206. An alternate antennae (not shown) may be used to send and receive command signals as generally described above. Other types of scanners and receivers for sending and receiving signals and data known by those skilled in the art may be used. Through such communication and the sending and receiving of signals, the AGV is accurately and precisely positionally monitored and guided to the desired position. This positional and instructional communication between the pallet 206 and AGV 220 can further be controlled, monitored and/or supplemented from a remote controller and command center (not shown) in the plant as generally described above.

In the example illustrated, AGV 220 further includes locating pins 280 (four shown) extending upward from the upper surface 260. As further described below, the pins 280 are connected to an actuator allowing the pins to selectively and synchronously be raised and lowered from an elevated position to a position substantially flush with the upper surface 260. The respective pins 280 may be connected to a mechanical linkage (not shown) to an electric motor or other actuation device to raise or lower the pins on the controller's receipt of a signal or other trigger to raise or lower the pins 280 as desired. Other methods to raise or lower the pins 280 including pneumatic, hydraulic, magnetic as well as others known by those skilled in the art may be used.

Referring to FIGS. 5-7, in a preferred example, a plurality of FAMs 200 including pallets 206 are organized in a staging area and generally positioned in a sequential formation as shown in FIG. 5. The spacing of individual pallets 206 along axis 34 from one another can vary as desired and maybe have distance for users to walk between them or little or no space and be butted up against one another to create a substantially continuous working platform or surface so users can maneuver around the vehicle bodies 12 as desired.

On selected initiation of an assembly process along assembly line 34, one or more AGV's 220 are activated and moved along a predetermined path of travel through execution or receipt of signals from a resident or remote controller as described above. As best seen in FIG. 5 an AGV is moved through execution of preprogrammed instructions and/or receipt of signals toward a pallet 206 and aligned with docking station 230 as generally shown. The AGV moves into the recess 230 as best seen in FIGS. 6 and 7 at which time pins 280 are actuated and extended upward to engage coordinating receptacles (not shown) adjacent the access 230 operatively connecting the AGV 220 to the pallet 206. It is understood that other structures or methods to operatively engage AGV to the pallet known by those skilled in the art may be used.

On operational engagement of the AGV 220 to the pallet 206, the pallet may be selectively driven along the assembly line or predetermined path of travel 34 by the powered AGV through receipt of stored software or program commands sent to or executed by the AGV. As shown in FIG. 5, an AGV 220 is assigned or engaged with each pallet 206 that will travel through the build process. It is understood that a lesser number of AGVs may be used depending on the weight or loads that the AGV must move. For example, where the build process allows the pallets 206 to be butted up against one another along the assembly line 34, only one AGV for every two or three pallets may be necessary to adequately keep the pallets moving.

In FIGS. 9-16 a third example of a FAM 300 and build processes used therewith are illustrated. Referring to FIGS. 9 and 10, exemplary FAM 300 includes a pallet 306, frame 310 and a vehicle body support 312 having a lifting mechanism as generally described above for the FAM 200 example. In the example, pallet 306 generally includes a larger upper surface 322, lower surface 326, front 332, rear 336 and wheels 328.

Exemplary pallet 306 frame 310 includes a pair of more robust pillars 340 without a cross member as shown in FAM 200. In a preferred example of lifting mechanism 316, a vehicle body carriage 352 includes each pillar having a support 354. As best seen in FIGS. 10-12, each support 354 includes a pair of telescopic arms 360 that adjust in length and rotate about a vertical axis to accommodate various vehicle bodies. Each arm includes a locating pin (not shown) which locates the particular vehicle. An attachment device (not shown) to secure the vehicle to the arm may be used as previously described.

As best seen in FIGS. 11 and 12 lifting mechanism 216 includes a base 358 that is rigidly connected to the arms 360. In a preferred example, each base 358 is connected to a vertical screw or worm drive at least partially housed inside a respective pillar 340 which is operably engaged with a motor 356 to selectively rotate and raise and lower the vehicle with respect to pallet upper surface 322. In one example, base 358 includes rollers 362 that rolling engage a portion of pillar 340 and a safety ratchet mechanism 366 which engages a rack (not shown) on the pillar to prevent unauthorized lowering of the vehicle 12. Other lifting structures and mechanism, for example, hydraulic, chain or cable driven and others known by those skilled in the art may be used.

Referring to FIGS. 13 and 14, in a preferred example, FAM 300 is powered and driven along a selected path of travel 34 by an induction power system 370 positioned in or on the plant floor previously described. Other methods of propelling the individual FAMs 300 previously described may be used. Through the described and preferred propulsion systems, the individual FAMs may selectively be moved along the path of travel 34 independent of one another at different intervals and different speeds. For example, along certain assembly lines or build stations, it may be advantageous for the FAM to approach the build station at a relatively high rate of speed and then slow the FAMs down as they approach or enter the build station so complex assembly operations can be performed. On exit of the station, the speed of the FAMs can increase back to normal or a different rate of speed to minimize time between stations and maximize build productivity rates. Through use of independent power signals and data communication with the pallet drive mechanisms, a flexible and highly efficient assembly sequence is attained.

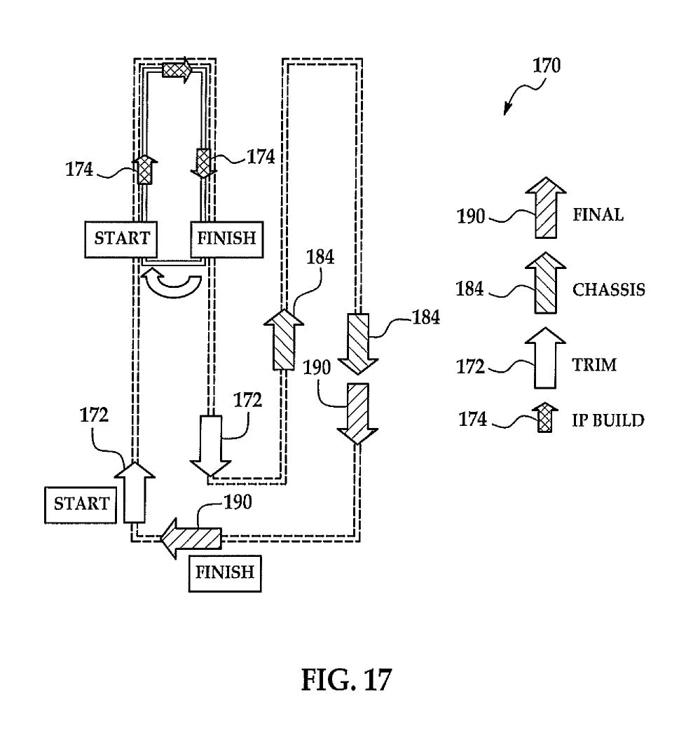

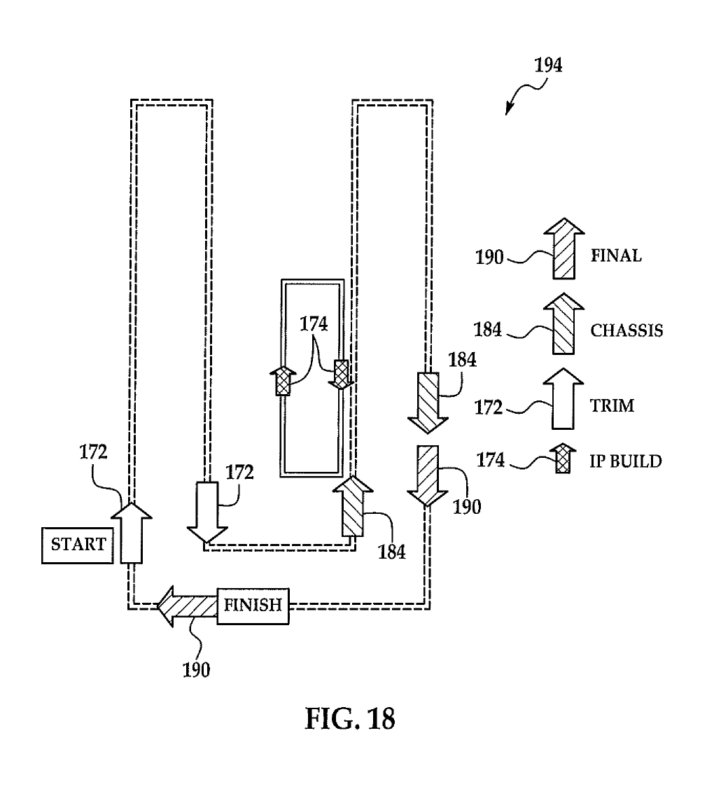

Referring to FIGS. 15 and 16, an example of the FAM in use in a decking operation, that is, attaching a preassembled vehicle powertrain and chassis to the vehicle body 12, is shown. In the example, pallet 306 including vehicle body 12 is positioned in a sequence of chassis installation cells or stations as procedurally shown in FIGS. 17 and 18. In a preferred process, the powertrain and chassis are assembled in a separate build area (not shown) and positioned on a separate decking cart or pallet 410 as best seen in FIGS. 15 and 16. The cart 410 is preferably positioned and oriented onto pallet 306 underneath the elevated body 12 as shown in FIG. 15. Once positioned, body 12 is lowered down toward cart 410 and robots 420 supported by scaffold 418 assist in the installation of the powertrain and chassis to the body 12. In a preferred process step, the vehicle with installed powertrain and chassis are raised by lifting mechanism 316 so the empty cart can exit and be returned to the adjacent chassis build area for reloading and staging for a subsequent FAM. In alternate examples, the pallet 306 and or decking cart 410 include means for positioning the cart 410 underneath the vehicle body 12 without the cart 410 physically positioned onto pallet upper surface 322. Other methods of decking or connecting the powertrain and chassis using the FAM known by those skilled in the art may be used.

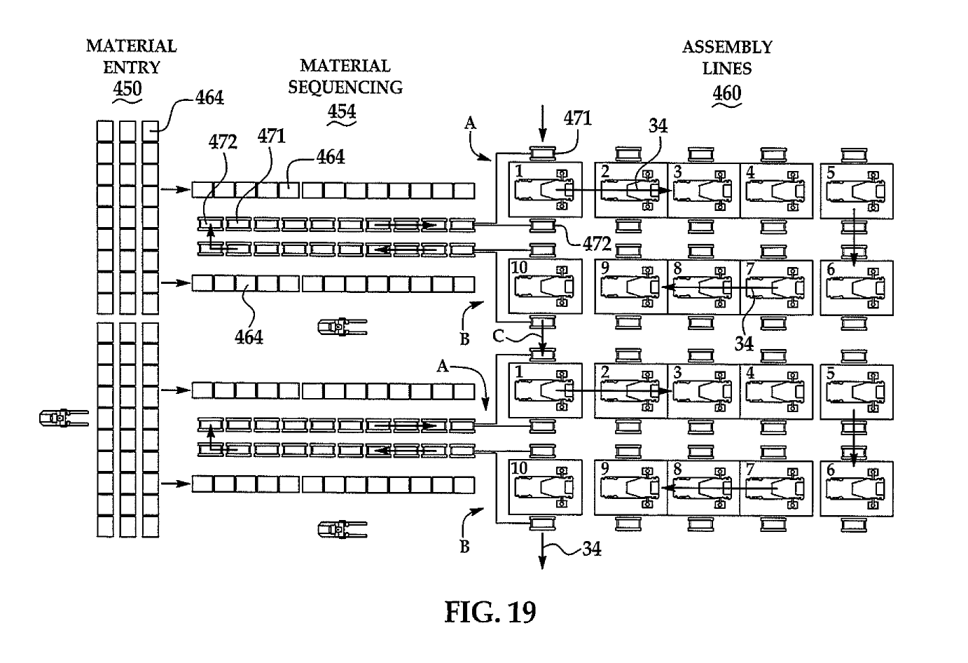

Referring to FIG. 9, in a preferred example and build process, FAM 300 (or 10 or 200) is used with one or more part trolleys or component carts 471, 472 (two shown). First 471 and second 472 part carts are removably connected to opposing sides of the pallet 306 and carry selected subassemblies and individual components for workers to retrieve and install on vehicle body 12. It is further contemplated that carts 471, 472 may further included part fixtures and hand-operated tools needed by the workers for a particular build station. Referring to FIG. 19, in one example, a plant floor layout includes a material entry area where bulk bins of components or subassemblies 464 are organized and warehoused by component or subassembly in high volumes. Adjacent to the material entry area is a material sequencing or marketplace area 454 where the respective part bins 464 needed to support a particular assembly line or sequence of build stations are transferred to and staged. The first 471 and second 472 part carts are sequenced and selectively loaded with sufficient components to support one complete cycle of the FAM and vehicle body 12 through the specific assembly line. Once loaded, the part carts are transferred in sequence from the material staging area at A into the assembly to the specific assembly line.

In a preferred example, two carts are connected to the awaiting FAM 300, one on each side of the pallet 306 as best seen in FIG. 9 (first cart 471 shown spaced from the pallet side for ease of illustration only). Each cart is removably connected to the pallet 306 and travels with the pallet along the specific assembly line until travel through the line is complete, or the pallet is depleted with components and is disconnected and returned to material sequencing area 454 for reloading for a subsequent FAM. In a most preferred example shown in FIG. 19, the end of the specific assembly line is directly adjacent to the material sequencing area 454 at B, so the empty carts can move directly out of the assembly line area back to the sequencing area 454 reducing congestion on the floor and difficulties transferring the empty carts, for example, from a distant area of the assembly plant. Although first 471 and second 472 are shown as connecting to the sides of pallet 306, alternate examples include positioning the carts to the rear 336 of the pallet or the carts being operative to be positioned on the pallet upper surface 322 for even more efficient access by the workers. Other methods of connection and access to the carts, including the number and orientation of the carts with respect to the pallet 306 known by those skilled in the art may be used. Further examples and details of the plant layout and process of material entry 450, material sequencing 454 and assembly lines 460 may be found in U.S. Patent Application Ser. No. 61/358,668 filed Jun. 25, 2010 assigned to the owner of the present application, the entire contents of which are incorporated herein by reference.

In addition to the part carts 471, 472, fixtures 476 may be positioned on pallet upper surface 476. These fixtures may, for example, provide a protected and secure place to temporarily position vehicle components such as finished door panels (two shown) while such panels are waiting initial or reinstallation on vehicle body 12.

It is understood that alternate FAMs 10, 200 and 300 may include, or substitute, one or more structural features, functions and build processes as described in the FAM 10 described above. For example, FAMs 200 and 300 may use the wheels 80 and motors 86 to power or self-propel pallet 206 instead of the AGV 220 described above. Other modifications and/or substitutions of structural components and functions of FAM 10 may be included on FAM 200, and visa versa, as known by those skilled in the art.

Referring to FIGS. 17 and 20, examples of a build process and methods of use of the inventive FAMs described above are illustrated and exemplify some of the advantages and flexibilities of the present invention. In a preferred example, use of the described FAMs may be used complete, or partially complete, the assembly of a passenger vehicle. In a typical application, production painted vehicle bodies are staged or stored in a holding area (not shown). In step 500 a plurality of FAMs are staged or positioned at or near the start of a predetermined assembly line 34 with several build stations.

In step 510, the predetermined assembly line path of travel is preprogrammed into a controller and/or processor having storage, execution and transmission capabilities. As noted above, these devices may be resident on the FAM 10/200 or may be housed remotely from the assembly line in another area in the assembly plant. If this equipment is remote, then the FAM 10/200 would receive appropriate signals through known wireless communication protocols from a receiver resident on the FAM for execution of the preprogrammed commands.

In step 520, the vehicle bodies 12 are sequentially maneuvered, installed and secured on the body supports 24/212 of the respective FAM. In the first example, FAM 10 control signals actuate the frame drive motors 86 to move the frame and body to the first build station for processing and then in step 560 along the path of travel 34 through the remaining build stations. In the alternate FAM example 200, in step 540 one or more AGVs 220 are guided and operatively engaged with a respective pallet 206 providing a powered driving means to the pallet which is then maneuvered to the first and subsequent build stations. In the third example, FAM 300 receives power, and optionally data signals, from induction power to begin driving and guiding the FAM 300 along a path of travel 34. It is understood that preprogramming and transmission of the predetermined assembly path of travel instructions or signals may occur before or after the vehicle bodies are installed in the FAM or the plurality of FAMs are organized or assembled near a start position on the assembly line.

In an alternate step (not shown) the operator interface 30 may provide visual and/or audio instructions or prompts to adjacent workers to carryout specific procedures at a particular build station. For example, where vertical movement of a body is not automatically programmed and executed, the interface may provide instruction how to adjust the height of the body or when to activate a particular actuator for a desired process or effect. In another example, a checklist may be displayed or require manual concurrence prior to the FAM being able to move to the next build station.

In an alternate step 530, first and second part carts 470 and 471 are preloaded with the appropriate subassemblies and component parts for the specific assembly line or sequence of build stations that the FAM will next pass through. As necessary, first 470 and second 471 loaded part carts are connected to the pallet 306 for travel along with the pallet 306 along the path of travel 34 through predetermined build stations.

As the FAMs are guided from build station to build station, a process step 580 may be employed to raise or lower the respective vehicle body 12 to a different vertical height along axis 40 to accommodate the particular build station to maximize efficiency, ease of access to the body 12 and safety of the users.

Through independent and sequential movement of the FAMs through the build stations, one or more trim, powertrain, chassis and interior components are sequentially installed to the body 12 in step 600. As shown in FIG. 17, the installation of the instrument panel (IP) 174 into the vehicle is staged prior to installation of the chassis components 184 which occurs prior to final assembly procedures 190. In FIG. 18, the instrument panel components are installed after installation of some, but not all, of the chassis components which may be advantageous and most efficient for a particular vehicle build based on many variables.

As best seen in FIG. 19, in a preferred example, the present invention is suitable for multiple, descrete groups of build stations or assembly lines 460 positioned in an assembly area. In a preferred example as described above, these assembly lines are positioned adjacent to a material sequencing area 454 where part carts are sequentially loaded with parts specific to the adjacent assembly line where such parts will be installed to the vehicle 12 carried by the FAM. On completion of a particular assembly line at B, in step 610, the part carts are detached from pallet 306 and immediately transitioned out of the assembly area back into the directly adjacent material sequencing area 454 for reloading of components onto the carts and staged for sequential reconnection to a subsequent FAM. This process of disconnecting the spent or depleted part carts 470,471 and reloading can simultaneously occur at each end of a discrete assembly line as shown in FIG. 19 (two lines shown).

In a preferred example, once the depleted part carts are removed and transitioned back to material sequencing area 454, in process step 615 the FAM pallet 306 can be driven and navigated to the start of the next and adjacent assembly line where loaded part carts 470, 471 are connected and the pallet 306 is driven through the next sequence of build stations. With the size of the pallet 306 and vehicle 12 positioned on the pallet and capable of adjustable height, workers can continue to work on the vehicle 12 even during transition periods between adjacent assembly lines as there is no physical transfer of the vehicle 12 from one conveyor to a separate conveyor like conventional vehicle assembly systems.

Since the FAMs are independently controlled and driven, increased flexibility is observed as selected FAMs may be directed to a separate path of travel for particular components to be installed, for example premium options not installed on all of the bodies 12, then reinserted back into the main assembly line 34 for further processing along with the other bodies that did not receive such components or processes. In another example, it is contemplated that different powertrains could be installed along the same assembly line. For example, vehicles designated as electric or hybrid vehicles could have electric motors and battery stacks staged in an adjacent path of travel and more traditional internal combustion engine components along the main path of travel. The bodies designated for electric power could be raised to another set of build stations or independently diverted from the main line and reinserted back into the main line for common trim or other components to complete the vehicle.

For example, the present invention contemplates a second assembly line or path of travel that is positioned vertically above and over an assembly line 34 is resides on the assembly plant ground floor. All or a selected few of the FAMs may raise the bodies 12 vertically upward along axis 40 above the lower assembly line 34 for selected processing while the remaining vehicles continue the path of travel 34. This two-level assembly plant may be particularly advantageous where floor space is at a premium.

Additional advantages and flexibilities to the invention and the independent control and movement of each FAM resides in the ability to selectively remove one or more FAMs from the assembly process. For example, if an error or irregularity occurs in a build station and a repair or reprocessing is required, the particular FAM can be guided out of the assembly line and moved to a repair area without stopping the assembly line, altering the production schedule or continued processing of the other FAMs.

When the FAMs have traveled through all of the predetermined build stations, the completed or partially completed vehicle bodies are unsecured and removed from the FAM in step 620. In a preferred example, body 12 is a complete, fully-functional vehicle and is driven or otherwise moved to a finished vehicle storage area for additional processing and transportation from the assembly plant.

In step 640, the now empty FAM is either driven and guided back to the start of the assembly process to receive another vehicle body 12 or to a holding or storage area until activated for use.

The FAMs, since independently moveable with respect to one another and having their own onboard drive source 20/220 do not suffer from the limitations of traditional assembly facilities and assembly lines requiring structural conveyors or transports that are physically built into the plant floor or on overhead trusses. This further eliminates the prior need to transition or “hand-off” bodies from one conveyor system to another. Since the FAMs are selectively guided and self-powered along a selected path of travel, there is no transitioning from one conveyor system to another. The FAM build process and methods of use further greatly reduce the amount of non-productive build time and travel of traditional build processes and conveyors. For example, in prior structures and processes, the vehicle bodies required travel through below floor pits and other areas where the bodies could not be accessed or worked on by workers or machines. The present invention permits significantly increased access to the vehicle body 12 along substantially the entire assembly line 34, and thus productive building and assembly time, greatly increasing the speed and efficiency of the assembly process. As a significant amount of non-productive build time is removed, the present invention provides for high density assembly compared to prior build processes.

In a preferred application, an existing or largely unimproved facility can be converted to an assembly facility as many of the structural and physical requirements such as overhead trusses and below floor pits are not needed as the FAMs can operate on a hard, substantially planar floor. The build stations can be sequentially positioned and component bins, utility carts and tables (not shown) may be used to store or stage the parts to be installed and secured can be positioned along assembly line 34 thereby greatly reducing the investment in the previously required structural features necessary to establish a high production vehicle assembly line.

In addition, the plant facility and build process can employ logistical areas such as material entry areas 450, material sequencing areas 454 wherein the component carts can be preloaded and staged before being mated with the FAM and vehicle body at a starting position of an assembly line. With the attached component carts having the required components to support the vehicle build for that particular assembly line, storage of component bins in the build stations next to the assembly line can be greatly reduced or eliminated further adding to the efficiency of the build process and capital structure and architecture of the assembly plant.

Without the need for traditional, built-in and plant dedicated vehicle body conveyors, and due to the self-powered individual FAMs, if there is failure or problem with one of the FAMs 10 between or at building stations, the FAM 10 can individually be moved out of the assembly line 34 while the remaining FAMs 10 continue along the line substantially uninterrupted. When the problem or failure is remedied, the particular FAM 10 can be repositioned in the build process to complete the build.

Other significant advantages of the described example include that the body 12 can be selectively be raised or lowered as desired from build station to build station to accommodate the particular components to be installed and secured. The desired sequence of raising and lowering of body 12 during the FAM path of travel can be preprogrammed into a controller in electronic communication with the lifting device 26 that is secured or resident on the FAM 10. Alternately, the controller, processor and memory can be in a separate area of the assembly plant and actuation signals can be sent from the controller wirelessly through known equipment and communication protocols to a receiver on the FAM for execution and actuation of the lifting device. In another example, raising and lowering of body 12 may be accomplished by a user actuating push buttons or levers on the frame 14 to raise or lower the body 12 as desired. In one example, the operator interface may provide video and/or audio prompts and instructions to guide a user to position the body 12 for a particular build station or assembly process.

Due to the open architecture of the FAM 10, frame 14 and body support 24, substantially improved user access to body 12 is achieved around the full 360 degrees around the vehicle which increases efficiency of the build, quality of the build and safety for the adjacent workers.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An assembly machine for use in the sequential manufacture and assembly of passenger vehicles having a skeletal vehicle body structure through a plurality of build stations positioned along a predetermined assembly path of travel, the assembly device comprising:
a frame positioned along a predetermined assembly line path of travel;
a body support connected to the frame adapted to support the vehicle body structure;
a lift device operably connected to the frame and the body support for selective movement of the body support and vehicle body along a vertical axis relative to the frame; and
a powered drive operatively engaged with the frame adapted to selectively move the frame and vehicle body along the assembly path of travel through the build stations.

2. The assembly machine of claim 1 wherein the frame further comprises:
at least two pillars extending upward along the vertical axis, the at least two pillars operatively connected to the lift device and body support.

3. The assembly machine of claim 2 wherein the frame further comprises:
a plurality of wheels connected to the frame adapted for rolling engagement with an assembly device support surface positioned along the predetermined path of travel.

4. The assembly machine of claim 3 wherein at least two of the wheels are in operative engagement with the powered drive, the powered drive operative to forcibly rotate the at least two of the wheels to independently drive the assembly device along the predetermined path of travel.

5. The assembly machine of claim 4 wherein the powered drive comprises:
an induction motor connected to the frame;
and a power source separate and independent of the frame, the power source adapted to be in electrical communication with the induction motor to supply power to the motor and drive the frame along the predetermined path of travel.

6. The assembly machine of claim 3 wherein the frame further comprises:
a pallet having a substantially planar upper surface supporting the pillars and a lower surface, the plurality of wheels connected to the lower surface.

7. The assembly machine of claim 6 wherein the powered drive comprises:
an induction motor connected to the pallet;
and a power source separate and independent of the pallet, the power source adapted to be in electrical communication with the induction motor to supply power to the motor and drive the frame along the predetermined path of travel.

8. The assembly machine of claim 6 wherein the powered drive comprises a separate and independent automated guided vehicle (AGV) selectively and operatively engagable with a pallet docking station, the AGV having a controller, a power source and omni-directional wheels to forcibly drive the pallet along the predetermined assembly path of travel.

9. The assembly machine of claim 2 wherein the frame comprises four pillars separated from one another about the assembly line path of travel and a lateral axis, the pillars each having a wheel, at least two of the wheels operably connected to the power drive.

10. The assembly machine of claim 9 further comprising:
at least two longitudinal beams connected to at least two lateral beams;
a support connected to the two longitudinal beams, the support adapted to securely and removably connect to the vehicle body;
a plurality of drums operably connected to an electric motor for selected rotation of the drums; and
at least two straps connected to the longitudinal and lateral members, the cables in frictional engagement with the drums wherein on selective activation of the motor, the support and vehicle body are raised or lowered along the vertical axis.

11. The assembly machine of claim 1 further comprising a human machine interface connected to the frame, the interface having an audio and visual display panel adapted to convey build data to adjacent users.

12. An assembly machine for use in the sequential manufacture and assembly of passenger vehicles having a skeletal vehicle body structure through a plurality of build stations positioned along a predetermined assembly path, the assembly device comprising:
a frame having a pallet, at least two elongate pillars extending upward from an upper surface of the pallet along a substantially vertical axis, and a plurality of wheels connected to a bottom surface of the pallet;
a body support connected to each of the pillars adapted to support the vehicle body structure;
a lift device operably connected to the pillars and each body support for selective movement of the body support and vehicle body along the vertical axis relative to the pallet upper surface; and
a powered drive operative to selectively and independently move the pallet and vehicle body along the assembly path of travel through the build stations.

13. The assembly machine of claim 12 further comprising at least one separate and independent component cart removably engaged with the pallet for travel with the pallet along the predetermined path of travel, the cart adapted to provide components to be selectively retrieved and connected to the vehicle body at the plurality of build stations.

14. The assembly machine of claim 12 wherein the power drive comprises:
an automated guided vehicle (AGV) selectively and operably engageable with a docking station on the pallet, the AGV having a power source accessible by the pallet and operative to forcibly drive at least two of the wheels connected to the pallet along the predetermined path of travel.

15. The assembly machine of claim 12 wherein the power drive comprises:
at least one electric motor connected to the pallet in operative engagement with at least one of the wheels to forcibly drive the pallet along the predetermined path of travel.

16. The assembly machine of claim 12 further comprising at least one of a controller and a receiver connected to the pallet for receipt and execution of data signals to guide the pallet along the predetermined path of travel and to monitor the logistical position of the pallet.

17. The assembly machine of claim 12 wherein each body support further comprises:
a base connected to the respective pillar and in operable engagement with the lift device; and
at least two telescopic support arms connected to the base and angularly separated from one another, at least one of the two support arms extending in a direction generally toward the opposing pillar.

18. A method of assembly for use in the sequential build and assembly of passenger vehicles, the method comprising the steps of:
providing at least one assembly machine having a frame, a vehicle body support, a lift mechanism and a powered drive;
installing a partially completed vehicle body in the assembly machine in supporting engagement with the lift mechanism;
selectively moving the assembly machine by the powered drive from a start position along a predetermined assembly line path of travel through a plurality of build stations;
selectively and independently raising or lowering the vehicle body using the lift mechanism to maximize accessibility of the vehicle body at the respective plurality of build stations; and
sequentially installing one or more components to the vehicle body at the respective build stations along the assembly line path of travel until a predetermined level of vehicle body assembly is complete.

19. The method of claim 18 wherein the method of providing at least one assembly machine further comprises the step of:
providing a plurality of assembly machines selectively and independently positioned and movable along the predetermined assembly path of travel, each assembly machine adapted to raise and lower the respective vehicle body independent of the other assembly machines.

20. The method of claim 18 further comprises the steps of:
removably engaging at least one separate and independent component cart to the assembly machine for travel of the assembly machine and connected component cart along the predetermined assembly path of travel; and
sequentially and selectively retrieving the desired component to be installed from the component cart at the respective build station.

21. The method of claim 20 further comprising the step of:
selectively disengaging the component cart from the assembly machine when the component cart is depleted with components; and
returning the component cart to a restocking area to be reloaded with components to support a subsequent assembly machine and respective vehicle body.

22. The method of claim 18 further comprising the step of preprogramming the predetermined assembly line path of travel into a controller in electronic communication with the powered drive.

23. The method of claim 18 wherein the step of moving the assembly machine further comprises the step of selectively connecting a self-propelled automated guided vehicle (AGV) to the assembly machine to independently drive the assembly machine along the predetermined path of travel.

24. The method of claim 23 wherein the step of connecting the self-propelled automated guided vehicle to the assembly machine further comprises the steps of:
guiding the automated guided vehicle to a predetermined assembly machine; and
operably engaging the automated guided vehicle with a docking station on the assembly machine.

25. The method of claim 19 further comprising the step of selectively and independently removing one of assembly machines from the sequentially ordered plurality of assembly machines when an error in the assembly process occurs.

26. The method of claim 18 further comprises the step of providing audio and visual communication of instructive assembly data through an human machine interface panel connected to the assembly machine.

27. An assembly machine for use in the sequential manufacture and assembly of passenger vehicles having a skeletal vehicle body structure through a plurality of build stations positioned along a predetermined assembly path of travel, the assembly device comprising:
means for providing at least one assembly machine having a frame, a vehicle body support, a lift mechanism and a powered drive;
means for securing a partially completed vehicle body in the assembly machine in supporting engagement with the lift mechanism;
means for selectively moving the assembly machine by the powered drive from a start position along a predetermined assembly line path of travel through a plurality of build stations;
means for selectively and independently raising or lowering the vehicle body using the lift mechanism to maximize accessibility of the vehicle body at the respective plurality of build stations; and
means for sequentially installing one or more components to the vehicle body at the respective build stations along the assembly line path of travel until a predetermined level of vehicle body assembly is complete.
